(19) United States
(12) Patent Application Publication
(10) Pub. No.: US 2023/0224769 A1
(43) Pub. Date: Jul. 13, 2023

(54) METHOD AND APPARATUS FOR CONTROLLING DATA TRANSMISSION RATE COMMUNICATION DEVICE, AND STORAGE MEDIUM

(71) Applicant: Beijing Xiaomi Mobile Software Co., Ltd., Beijing (CN)

(72) Inventor: Yang LIU, Beijing (CN)

(21) Appl. No.: 17/997,349

(22) PCT Filed: Apr. 30, 2020
(86) PCT No.: PCT/CN2020/088240

§ 371 Date: Oct. 27, 2022

(51) Int. Cl. H04W 36/00; H04W 28/06

(52) U.S. Cl. CPC H04W 36/0027; H04W 36/0072; H04W 28/06

(57) ABSTRACT

A method for controlling a data transmission rate, performed by a session management function (SMF), and includes: according to the maximum data rate for a terminal using a network slice, determining the session aggregate maximum bit rate (session-AMBR) of a packet data unit (PDU) session for the terminal to perform data transmission using the network slice, wherein the session-AMBR of the PDU session is less than or equal to the session-AMBR of a PDU session subscribed to by the terminal.

### TECHNICAL FIELD

The disclosure relates to the technical field of wireless communication, in particularly, to a method and apparatus for controlling a data transmission rate, a communication device, and a storage medium.

### BACKGROUND

A network slice technology is a technology that switches one physical network into a plurality of virtual end-to-end networks. On the one hand, each virtual network can obtain logically independent network resources, and network slices can be isolated from each other. Thus, when an error or failure occurs in one network slice, it will not affect other network slices. On the other hand, the advantage of the network slices is that they allow network operators to choose the required characteristics of each network slice according to their needs, such as low latency, high throughput, high connection density, high spectral efficiency, etc. Moreover, the operators can change and add the characteristics of the network slices without considering the impact of the rest of the network, which saves time and reduces costs.

In the network slice technology, the network can limit a session aggregate maximum bit rate (session-AMBR) of one packet data unit (PDU) session in a network slice and a UE aggregate maximum bit rate (UE-AMBR) of one terminal according to the agreement between the operator and a user.

### SUMMARY

The disclosure discloses a method and apparatus for controlling a data transmission rate, a communication device, and a storage medium.

An example of the disclosure discloses a method for controlling a data transmission rate, applied to a session management function (SMF), and including:

determining, according to a maximum data rate for a terminal using a network slice, a session aggregate maximum bit rate (session-AMBR) of a packet data unit (PDU) session for the terminal to perform data transmission using the network slice, the session aggregate maximum bit rate (session-AMBR) of the packet data unit (PDU) session being less than or equal to a session aggregate maximum bit rate (session-AMBR) of a packet data unit (PDU) session subscribed to by the terminal.

According to a second aspect of the example of the disclosure, a communication device is provided, and includes:

a processor; and

a memory, configured to store processor-executable instructions.

The processor is configured to implement the method described by any example of the disclosure by executing the computer-executable instructions.

According to a third aspect of the example of the disclosure, a non-transitory computer storage medium is provided, which stores computer-executable programs, and the computer-executable programs implement the method described by any example of the disclosure when being executed by a processor.

### BRIEF DESCRIPTION OF THE DRAWINGS

FIG. 1 is a schematic structural diagram of a wireless communication system according to an example.

FIG. 2 is a flowchart of a communication network architecture illustrated according to an example.

FIG. 3 is a flowchart of a method for controlling a data transmission rate illustrated according to an example.

FIG. 4 is a flowchart of a network slice illustrated according to an example.

FIG. 5 is a flowchart of a method for controlling a data transmission rate illustrated according to an example.

FIG. 6 is a flowchart of a method for controlling a data transmission rate illustrated according to an example.

FIG. 7 is a flowchart of a method for controlling a data transmission rate illustrated according to an example.

FIG. 8 is a flowchart of a method for controlling a data transmission rate illustrated according to an example.

FIG. 9 is a flowchart of a method for controlling a data transmission rate illustrated according to an example.

FIG. 10 is a flowchart of a method for controlling a data transmission rate illustrated according to an example.

FIG. 11 is a flowchart of a method for controlling a data transmission rate illustrated according to an example.

FIG. 12 is a flowchart of a method for controlling a data transmission rate illustrated according to an example.

FIG. 13 is a block diagram of an apparatus for sending data illustrated according to an example.

FIG. 14 is a block diagram of user equipment illustrated according to an example.

FIG. 15 is a block diagram of a base station illustrated according to an example.

### DETAILED DESCRIPTION

Examples will be described in detail here, and instances of which are shown in the accompanying drawings. When the following description refers to the accompanying drawings, unless otherwise indicated, the same numbers in different accompanying drawings indicate the same or similar elements. The implementations described in the following examples do not represent all implementations consistent with the examples of the disclosure. Rather, they are merely instances of apparatuses and methods consistent with some aspects of the examples of the disclosure as detailed in the appended claims.

The terms used in the examples of the disclosure are merely for the purpose of describing specific examples, and not intended to limit the examples of the disclosure. The singular forms “one” and “the” used in the examples of the disclosure and the appended claims are also intended to include the plural forms unless the context clearly indicates other meanings. It needs also to be understood that the term “and/or” as used here refers to and includes any or all possible combinations of one or more associated listed items.

It needs to be understood that although the terms first, second, third, etc. may be used to describe various information in the examples of the disclosure, such information should not be limited to these terms. These terms are merely used to distinguish the same type of information from each other. For instance, without departing from the scope of the examples of the disclosure, first information may also be referred to as second information, and similarly, the second information may also be referred to as the first information. Depending on the context, the word “if” as used here may be interpreted as “at the time” or “when” or “in response to determining”

Please refer to FIG. 1, which illustrates a schematic structural diagram of a wireless communication system provided by an example of the disclosure. As shown in FIG. 1, the wireless communication system is a communication system based on a cellular mobile communication technology. The wireless communication system may include: a plurality of user devices 110 and a plurality of base stations 120.

The user device 110 may refer to devices that provide a user with voice and/or data connectivity. The user device 110 may communicate with one or more core networks via a radio access network (RAN). The user device 110 may be user devices of Internet of Things, such as sensor devices, mobile phones (or called “cellular” phones) and computers with the user devices of Internet of Things, for instance, may be fixed, portable, pocket-size, handheld, computer built-in or vehicle-mounted apparatuses. For instance, the user device 110 may be a station (STA), a subscriber unit, a subscriber station, a mobile station, a mobile, a remote station, an access point, a remote terminal, an access terminal, a user terminal, a user agent, a user device or user equipment. Or, the user device 110 may also be unmanned aircraft devices. Or, the user device 110 may also be vehicle-mounted devices, such as a trip computer with a wireless communication function, or a wireless user equipment connected with an external trip computer. Or, the user device 110 may also be roadside devices, such as a street lamp, a signal light or other roadside devices with wireless communication functions.

The base stations 120 may be network side devices in the wireless communication system. The wireless communication system may be the 4th generation mobile communication (4G) system, also known as a long term evolution (LTE) system; or the wireless communication system may also be a 5G system, also known as a new radio (NR) system or a 5G NR system. Or, the wireless communication system may also be a next-generation system of the 5G system. An access network in the 5G system may be called a new generation-radio access network (NG-RAN).

The base stations 120 may be evolved base stations (eNB) adopted in the 4G system. Or, the base stations 120 may also be base stations (gNB) adopting centralized and distributed architectures in the 5G system. When the base stations 120 adopt the centralized and distributed architectures, they typically each include a central unit (CU) and at least two distributed units (DUs). Protocol stacks of a packet data convergence protocol (PDCP) layer, a radio link control (RLC) layer and a media access control (MAC) layer are disposed in the central unit; and protocol stacks of physical (PHY) layers are disposed in the distributed units, and specific implementations of the base stations 120 are not limited in the example of the disclosure.

The base stations 120 and the user devices 110 may establish wireless connection through a wireless air interface. In different implementations, the wireless air interface is a wireless air interface based on the 4G standard; or, the wireless air interface is a wireless air interface based on the 5G standard, such as a new radio; or, the wireless air interface may also be a wireless air interface based on the next-generation mobile communication standard of 5G.

In some examples, the user devices 110 may also establish end to end (E2E) connection. For instance, vehicle to vehicle (V2V) communication, vehicle to infrastructure (V2I) communication and vehicle to pedestrian (V2P) communication in vehicle to everything (V2X) communication and other scenarios.

Here, the above user device may be considered as a terminal device of the following examples.

In some examples, the above wireless communication system may further include a network management device 130.

The plurality of base stations 120 are connected with the network management device 130 respectively. The network management device 130 may be a core network device in the wireless communication system, for instance, the network management device 130 may be a mobility management entity (MME) in an evolved packet core (EPC). Or, the network management device may also be other core network devices, such as a serving gateway (SGW), a public data network gateway (PGW), a policy and charging rules function (PCRF) or a home subscriber server (HSS). The implementation form of the network management device 130 is not limited in the example of the disclosure.

In order to facilitate the understanding of any example of the disclosure, firstly, an example is used to describe the 5G system architecture that applies the control of a data transmission rate.

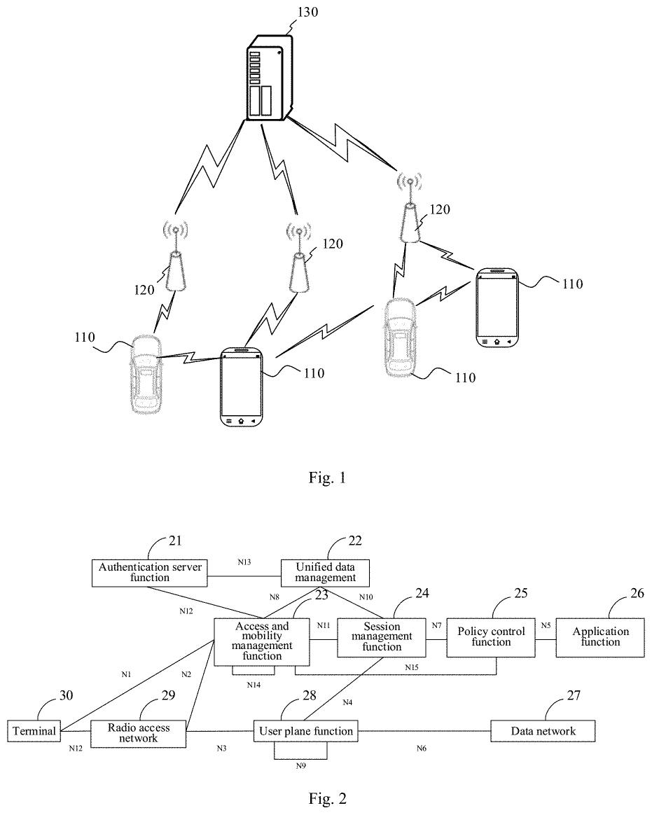

As shown in FIG. 2, the 5G system architecture includes the following network elements: an authentication server function (AUSF) 21, a unified data management (UDM) 22, an access and mobility management function (AMF) 23, a session management function (SMF) 24, a policy control function (PCF) 25, an application function (AF) 26, a data network (DN) 27, a user plane function (UPF) 28, a radio access network (RAN) 29, a terminal 30 and the like. The terminal 30 is connected to the access and mobility management function 23 through an N1 interface; the radio access network 29 is connected to the access and mobility management function 23 through an N2 interface; the radio access network 29 is connected to an entity of the user plane function 28 through an N3 interface; the user plane function 28 is connected to the session management function 24 through an N4 interface; the policy control function 25 is connected to the application function 26 through an N5 interface; the user plane function 28 is connected to the data network 27 through an N6 interface; the session management function 24 is connected to the policy control function 25 through an N7 interface; the access and mobility management function 23 is connected to the unified data management 22 through an N8 interface; the user plane functions 28 are mutually connected through an N9 interface; the unified data management 22 is connected to the session management function 24 through an N10 interface; the access and mobility management function 23 is connected to the session management function 24 through an N11 interface; the authentication server function 21 is connected to the access and mobility management function 23 through an N12 interface; the authentication server function 21 is connected to the unified data management 22 through an N13 interface; the access and mobility management functions 23 are mutually connected through an N14 interface; and the access and mobility management function 23 is connected to the policy control function 25 through an N15 interface. In one example, the method for controlling the data transmission rate of any example of the disclosure may be applied to the session management function (SMF) 24.

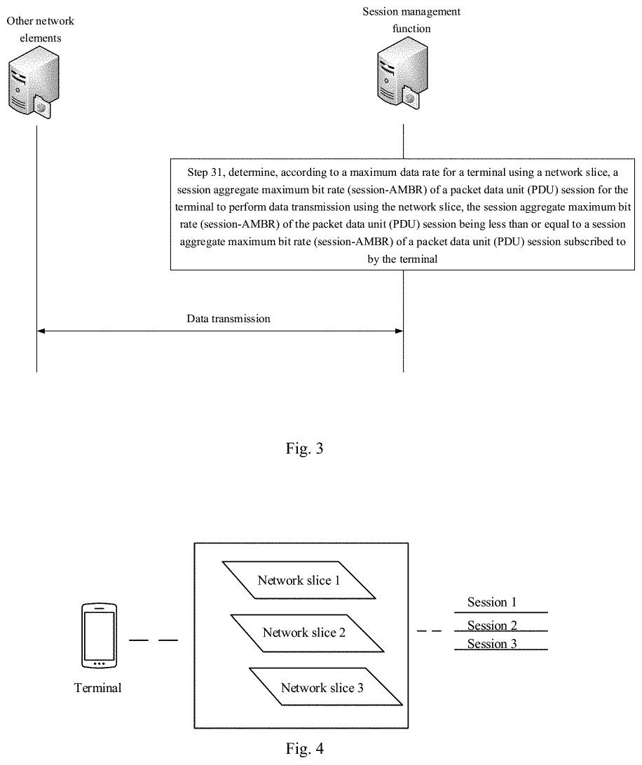

As shown in FIG. 3, an example provides a method for controlling a data transmission rate, applied to a session management function (SMF), and including:

step 31, according to a maximum data rate for a terminal using a network slice, a session aggregate maximum bit rate (session-AMBR) of a packet data unit (PDU) session for the terminal to perform data transmission using the network slice is determined. The session aggregate maximum bit rate (session-AMBR) of the packet data unit (PDU) session is less than or equal to a session aggregate maximum bit rate (session-AMBR) of a packet data unit (PDU) session subscribed to by the terminal.

Here, the terminal may be, but not limited to a mobile phone, a wearable device, a vehicle-mounted terminal, a road side unit (RSU), a smart home terminal, an industrial sensing device and/or a medical device.

In the example of the disclosure, according to the maximum data rate for the terminal using the network slice, the session aggregate maximum bit rate (session-AMBR) of the packet data unit (PDU) session for the terminal to perform data transmission using the network slice is determined, and the session aggregate maximum bit rate (session-AMBR) of the packet data unit (PDU) session is less than or equal to the session aggregate maximum bit rate (session-AMBR) of the packet data unit (PDU) session subscribed to by the terminal. Here, the maximum data rate is further set for each network slice, the maximum data transmission rate of each network slice may be limited, compared with a mode of limiting merely the session aggregate maximum bit rate (session-AMBR) of the packet data unit (PDU) session and the UE aggregate maximum bit rate (UE-AMBR) of the terminal, limiting the session aggregate maximum bit rate (session-AMBR) of the packet data unit (PDU) session according to the maximum data rate of each network slice can make the data transmission rate control of the network slices more accurate.

In one example, each terminal may access a plurality of different network slices; and each network slice may include a plurality of different packet data unit (PDU) sessions. For instance, please refer to FIG. 4, the terminal accesses three different network slices, namely a network slice 1, a network slice 2 and a network slice 3. The network slice 2 includes 3 packet data unit (PDU) sessions, namely a session 1, a session 2 and a session 3. Here, the packet data unit (PDU) session may be a connection between the terminal and a packet data network.

In one example, different network slices may correspond to different types of application scenarios. For instance, the network slice 1 is applied to an enhanced mobile broadband (eMBB) scenario; the network slice 2 is applied to a massive machine type communication (mMTC) scenario; and the network slice 3 is applied to an ultra reliable & low latency communication (uRLLC) scenario.

In one example, the maximum data rate is used for representing the ability of each network slice to transmit data. Here, data transmitted by each network slice per unit time cannot be larger than the maximum data rate.

In one example, a sum of the session aggregate maximum bit rates (session-AMBRs) of transmission data of the plurality of different packet data unit (PDU) sessions included by each network slice cannot be larger than the maximum data rate.

In one example, the maximum data rate may include a maximum up link (UL) data rate and a maximum down link (DL) data rate of one network slice.

In one example, the maximum up link data rates and the maximum down link data rates of all network slices accessed by the terminal are stored in the unified data management (UDM), and the session management function (SMF) may acquire the maximum up link data rate and the maximum down link data rate of any one of the network slices from the unified data management (UDM).

In one example, the magnitude of the maximum up link data rate and the maximum down link data rate of the network slice may be determined according to application scenarios. In one example, in an application scenario of live video playback, because the amount of down link data is large, and the amount of up link data is small, the maximum up link data rate may be set to be less than a first threshold, and the maximum down link data rate may be set to be larger than a second threshold. The first threshold is less than the second threshold. Here, the maximum up link data rate and the maximum down link data rate of the network slice are determined according to the application scenario, so that the overall transmission efficiency of the data of the network slice can be improved.

In one example, the maximum data rate of each network slice is evenly allocated to the session aggregate maximum bit rates (session-AMBRs) of the plurality of different packet data unit (PDU) sessions.

In one example, the maximum data rate of each network slice is unevenly allocated to the session aggregate maximum bit rates (session-AMBRs) of the plurality of different packet data unit (PDU) sessions. For instance, the maximum data rate of each network slice is 10 M, the network slice includes 3 packet data unit (PDU) sessions, namely a session 1, a session 2 and a session 3, then 3 M may be allocated to the session 1, 5 M may be allocated to the session 2, and 2 M may be allocated to the session 3.

In one example, each network slice may allocate all maximum data rates to the plurality of different packet data unit (PDU) sessions included by the network slices. In another example, each network slice may allocate parts of the maximum data rates to the plurality of different packet data unit (PDU) sessions included by the network slices.

In one example, each packet data unit (PDU) session corresponds to a subscribed session aggregate maximum bit rate (session-AMBR), and the data transmission rate of each packet data unit (PDU) session cannot be larger than the subscribed session aggregate maximum bit rate (session-AMBR).

In one example, the subscribed session aggregate maximum bit rate (session-AMBR) is the maximum up link data rate and/or the maximum down link data rate set by the network according to the agreement between the operator and the user. Here, the session aggregate maximum bit rate (session-AMBR) defines an upper limit of a sum of bit rates of all non-guaranteed bit rate (GBR) quality of service (QoS) flows of one packet data unit (PDU) session. The sum of the bit rates of all the non-guaranteed bit rate (GBR) quality of service (QoS) flows of one packet data unit (PDU) session cannot be larger than the session aggregate maximum bit rate (session-AMBR) of the packet data unit (PDU). In one example, different packet data unit (PDU) sessions may response to different subscribed session aggregate maximum bit rates (session-AMBRs). When the session aggregate maximum bit rate (session-AMBR) is subscribed by the terminal, there may be a plurality of session aggregate maximum bit rates for the terminal to select.

In one example, the session aggregate maximum bit rate (session-AMBR) subscribed by the packet data unit (PDU) session may be stored in the unified data management (UDM).

In the example of the disclosure, the maximum data rate is further set for each network slice, the maximum data transmission rate of each network slice may be limited, compared with a mode of limiting merely the session aggregate maximum bit rate (session-AMBR) of the packet data unit (PDU) session and the UE aggregate maximum bit rate (UE-AMBR) of the terminal, limiting the session aggregate maximum bit rate (session-AMBR) of the packet data unit (PDU) session according to the maximum data rate of each network slice can make the data transmission rate control of the network slices more accurate, and the efficiency of data transmission in the network slice is improved.

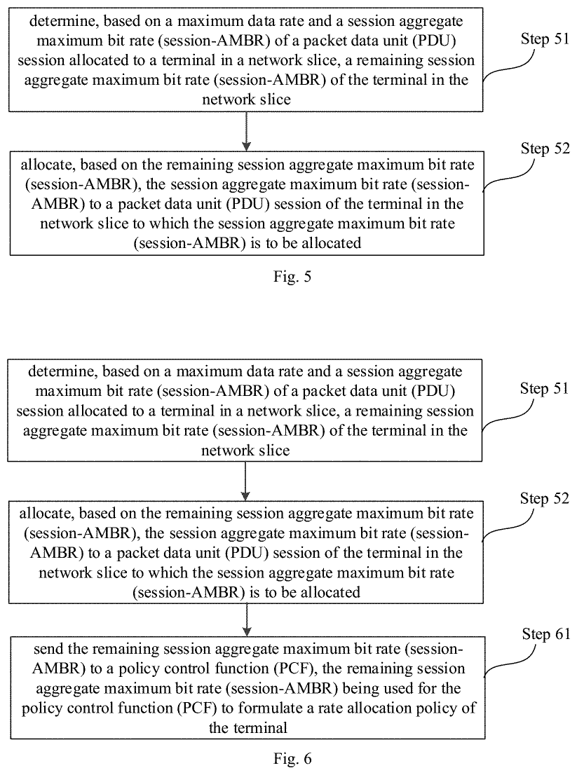

As shown in FIG. 5, an example provides a method for controlling a data transmission rate, in step 31, determining, according to the maximum data rate for the terminal using the network slice, the session aggregate maximum bit rate (session-AMBR) of the packet data unit (PDU) session for the terminal to perform data transmission using the network slice, includes:

step 51, based on the maximum data rate and a session aggregate maximum bit rate (session-AMBR) of a packet data unit (PDU) session allocated to the terminal in the network slice, a remaining session aggregate maximum bit rate (session-AMBR) of the terminal in the network slice is determined.

In one example, the network slice merely allocates part of the maximum data rate in the network slice to the session aggregate maximum bit rate (session-AMBR) of the packet data unit (PDU) session of the terminal.

In one example, 2 sessions have been established in the network slice, namely a packet data unit (PDU) session 1 and a packet data unit (PDU) session 2. The maximum data rate of the network slice is 10 M, where, the network slice allocates 2 M to the packet data unit (PDU) session 1, and allocates 2 M to the packet data unit (PDU) session 2, then the maximum data rate has 6 M remaining (the remaining 6 M is the currently available rate), and then it can be determined that the remaining session aggregate maximum bit rate (session-AMBR) of the terminal in the network slice is 6 M.

Here, after determining the remaining session aggregate maximum bit rate (session-AMBR) of the terminal in the network slice, the session aggregate maximum bit rate (session-AMBR) can be allocated to a to-be-established session based on the remaining session aggregate maximum bit rate (session-AMBR).

Step 52, based on the remaining session aggregate maximum bit rate (session-AMBR), the session aggregate maximum bit rate (session-AMBR) is allocated to a packet data unit (PDU) session of the terminal in the network slice to which the session aggregate maximum bit rate (session-AMBR) is to be allocated.

In one example, 2 sessions have been established in the network slice, namely a packet data unit (PDU) session 1 and a packet data unit (PDU) session 2. The maximum data rate of the network slice is 10 M, where, the network slice allocates 2 M to the packet data unit (PDU) session 1, and allocates 2 M to the packet data unit (PDU) session 2, then the maximum data rate has 6 M remaining (the remaining 6 M is the currently available rate), and then it can be determined that the remaining session aggregate maximum bit rate (session-AMBR) of the terminal in the network slice is 6 M.

In one example, if the session aggregate maximum bit rate (session-AMBR) of a packet data unit (PDU) session 3 subscribed by the terminal is 5 M, the remaining session aggregate maximum bit rate (session-AMBR) of 6 M cannot be all allocated to the packet data unit (PDU) session 3 to which the session aggregate maximum bit rate (session-AMBR) is to be allocated, and merely the remaining session aggregate maximum bit rate (session-AMBR) of 5 M will be allocated to the packet data unit (PDU) session 3 to which the session aggregate maximum bit rate (session-AMBR) is to be allocated.

Here, the allocation of the session aggregate maximum bit rate (session-AMBR) of the packet data unit (PDU) session to which the session aggregate maximum bit rate (session-AMBR) is to be allocated may further be limited by the session aggregate maximum bit rate (session-AMBR) subscribed by the terminal, so that the control of the data transmission rate of the network slice is more accurate.

As shown in FIG. 6, an example provides a method for controlling a data transmission rate, further including:

Step 61, the remaining session aggregate maximum bit rate (session-AMBR) is sent to a policy control function (PCF); and the remaining session aggregate maximum bit rate (session-AMBR) is used for the policy control function (PCF) to formulate a rate allocation policy of the terminal.

In one example, the rate allocation policy of the terminal may be a policy of allocating the remaining session aggregate maximum bit rate (session-AMBR) to the to-be-established session in the network slice.

In one example, the rate allocation policy of the terminal may be a policy authorized by the policy control function (PCF).

In one example, the remaining session aggregate maximum bit rate (session-AMBR) may be periodically sent to the policy control function (PCF).

In another example, each time the packet data unit (PDU) session is established, the remaining session aggregate maximum bit rate (session-AMBR) may be sent to the policy control function (PCF).

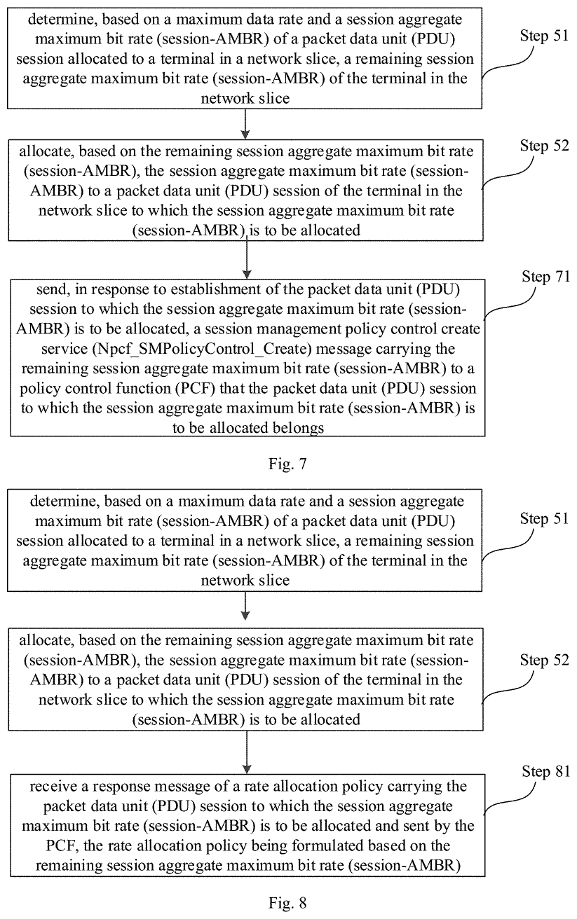

As shown in FIG. 7, an example provides a method for controlling a data transmission rate, and sending the remaining session aggregate maximum bit rate (session-AMBR) to the policy control function (PCF), includes:

Step 71, in response to establishment of the packet data unit (PDU) session to which the session aggregate maximum bit rate (session-AMBR) is to be allocated, a session management policy control create service (Npcf_SMPolicyControl_Create) message carrying the remaining session aggregate maximum bit rate (session-AMBR) is sent to a policy control function (PCF) that the packet data unit (PDU) session to which the session aggregate maximum bit rate (session-AMBR) is to be allocated belongs. Here, using the session management policy control create service (Npcf_SMPolicyControl_Create) message to send the remaining session aggregate maximum bit rate (session-AMBR) can improve the compatibility of the session management policy control create service (Npcf_SMPolicyControl_Create) message. At the same time, the message overhead of the network is reduced.

In one example, in response to that a plurality of packet data unit (PDU) sessions to which the session aggregate maximum bit rate (session-AMBR) is to be allocated are established simultaneously, the session management policy control create service (Npcf_SMPolicyControl_Create) message carrying the remaining session aggregate maximum bit rate (session-AMBR) may be merely sent to the policy control function (PCF) that the packet data unit (PDU) session to which the session aggregate maximum bit rate (session-AMBR) is to be allocated belongs once.

In one example, in response to that the plurality of packet data unit (PDU) sessions to which the session aggregate maximum bit rate (session-AMBR) is to be allocated are established successively, and when each packet data unit (PDU) session to which the session aggregate maximum bit rate (session-AMBR) is to be allocated is established, the session management policy control create service (Npcf_SMPolicyControl_Create) message carrying the remaining session aggregate maximum bit rate (session-AMBR) needs to be sent to the policy control function (PCF) that all the packet data unit (PDU) sessions to which the session aggregate maximum bit rate (session-AMBR) is to be allocated belong.

As shown in FIG. 8, an example provides a method for controlling a data transmission rate, further including:

step 81, a response message of a rate allocation policy carrying the packet data unit (PDU) session to which the session aggregate maximum bit rate (session-AMBR) is to be allocated and sent by the PCF is received; and the rate allocation policy is formulated based on the remaining session aggregate maximum bit rate (session-AMBR).

In one example, the rate allocation policy of the terminal may be a policy of allocating the remaining session aggregate maximum bit rate (session-AMBR) to the to-be-established session in the network slice.

In one example, the rate allocation policy of the terminal may be a policy authorized by the policy control function (PCF).

In one example, the remaining session aggregate maximum bit rate (session-AMBR) is 6 M. The session aggregate maximum bit rate (session-AMBR) of a packet data unit (PDU) session to which the session aggregate maximum bit rate (session-AMBR) is to be allocated subscribed by the terminal is 5 M, then the remaining session aggregate maximum bit rate (session-AMBR) of 5 M will be allocated to the packet data unit (PDU) session to which the session aggregate maximum bit rate (session-AMBR) is to be allocated.

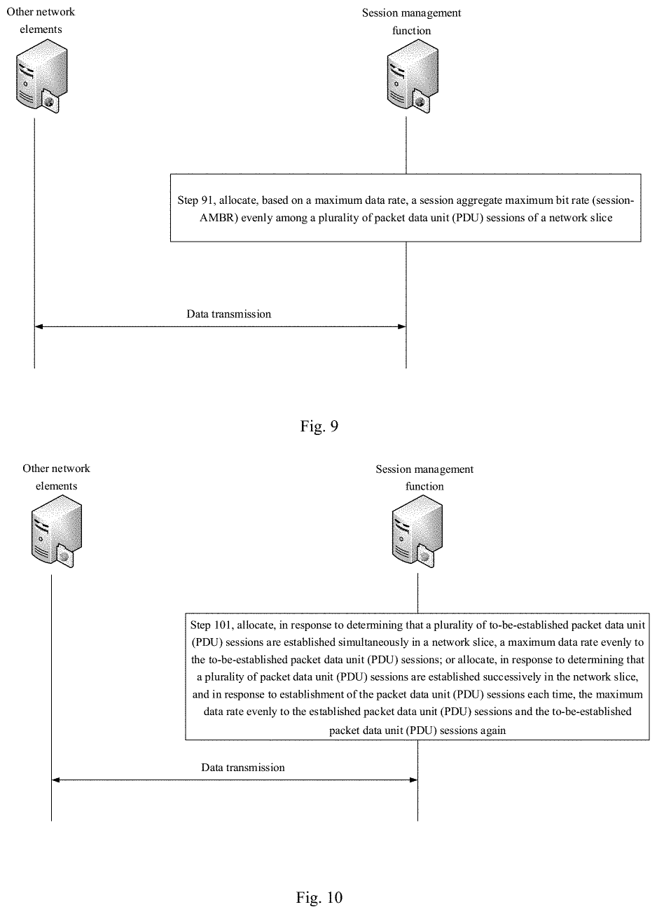

As shown in FIG. 9, an example provides a method for controlling a data transmission rate, in step 31, determining, according to the maximum data rate for the terminal using the network slice, the session aggregate maximum bit rate (session-AMBR) of the packet data unit (PDU) session for the terminal to perform data transmission using the network slice, includes:

step 91, based on the maximum data rate, the session aggregate maximum bit rate (session-AMBR) is allocated evenly among the plurality of packet data unit (PDU) sessions of the network slice.

In one example, all the maximum data rate may be allocated evenly to the plurality of packet data unit (PDU) sessions of the network slice. For instance, the maximum data rate is 6 M, and 6 M is all allocated to the plurality of packet data unit (PDU) sessions of the network slice.

In another example, part of the maximum data rate may be allocated evenly to the plurality of packet data unit (PDU) sessions of the network slice. For instance, the maximum data rate is 6 M, and merely 5 M is allocated to the plurality of packet data unit (PDU) sessions of the network slice.

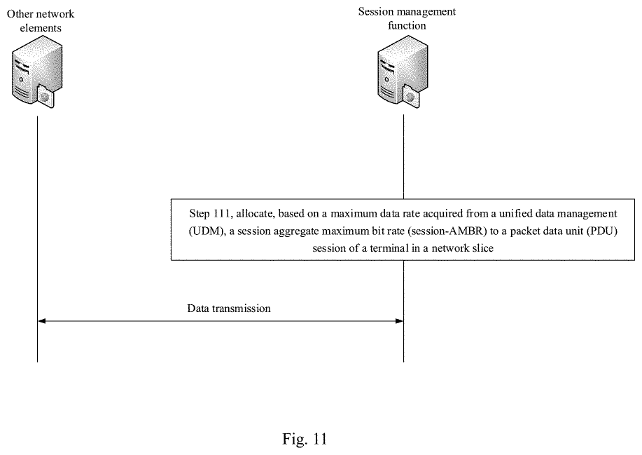

As shown in FIG. 10, an example provides a method for controlling a data transmission rate, in step 91, allocating the session aggregate maximum bit rate (session-AMBR) evenly among the plurality of packet data unit (PDU) sessions of the network slice, includes:

step 101, in response to determining that a plurality of to-be-established PDU sessions are established simultaneously in the network slice, the maximum data rate is allocated evenly to the to-be-established packet data unit (PDU) sessions;

or,

in response to determining that a plurality of packet data unit (PDU) sessions are established successively in the network slice, and in response to establishment of the packet data unit (PDU) sessions each time, the maximum data rate is allocated evenly to the established packet data unit (PDU) sessions and the to-be-established packet data unit (PDU) sessions again.

In one example, the maximum data rate of the network slice is 6 M, and the session aggregate maximum bit rate (session-AMBR) of the to-be-established packet data unit (PDU) session subscribed by the terminal is 6 M. There are 3 packet data unit (PDU) sessions in the network slice, and then the session aggregate maximum bit rate (session-AMBR) allocated to each to-be-established packet data unit (PDU) session is 2 M.

In one example, the maximum data rate of the network slice is 6 M, and the session aggregate maximum bit rate (session-AMBR) of the to-be-established packet data unit (PDU) session subscribed by the terminal is 6 M. At a first moment, when the packet data unit (PDU) session 1 is established, the session aggregate maximum bit rate (session-AMBR) allocated to the packet data unit (PDU) session 1 is 6 M. At a second moment, when the packet data unit (PDU) session 2 is established, the maximum data rate is allocated evenly to the established packet data unit (PDU) session 1 and the to-be-established packet data unit (PDU) session 2 again, then 3 M is allocated to the established packet data unit (PDU) session 1, and 3 M is allocated to the to-be-established packet data unit (PDU) session 2.

As shown in FIG. 11, an example provides a method for controlling a data transmission rate, in step 31, determining, according to the maximum data rate for the terminal using the network slice, the session aggregate maximum bit rate (session-AMBR) of the packet data unit (PDU) session for the terminal to perform data transmission using the network slice, includes:

step 111, based on the maximum data rate acquired from a unified data management (UDM), the session aggregate maximum bit rate (session-AMBR) is allocated to the packet data unit (PDU) session of the terminal in the network slice.

In one example, the maximum data rate may include a maximum up link (UL) data rate and a maximum down link (DL) data rate of one network slice. In one example, the maximum up link data rates and the maximum down link data rates of all network slices accessed by the terminal are stored in the unified data management (UDM), and the session management function (SMF) may acquire the maximum up link data rate and the maximum down link data rate of any one of the network slices from the unified data management (UDM).

In one example, the maximum data rate is a non-guaranteed bit rate (GBR) quality of service (QoS) flow bit rate. Here, the non-guaranteed bit rate (GBR) quality of service (QoS) flow means that the network does not limit a lowest data transmission rate. In the case of network congestion, the service needs to bear the requirement of reducing the rate. Since the non-guaranteed bit rate (GBR) quality of service (QoS) flow bearing does not need to occupy fixed network resources, it can be maintained for a long time.

In order to facilitate further understanding of the examples of the disclosure, the method for controlling the data transmission rate of the disclosure is further described through an example below.

### EXAMPLE 1

please refer to FIG. 2 again for a network architecture applying the method.

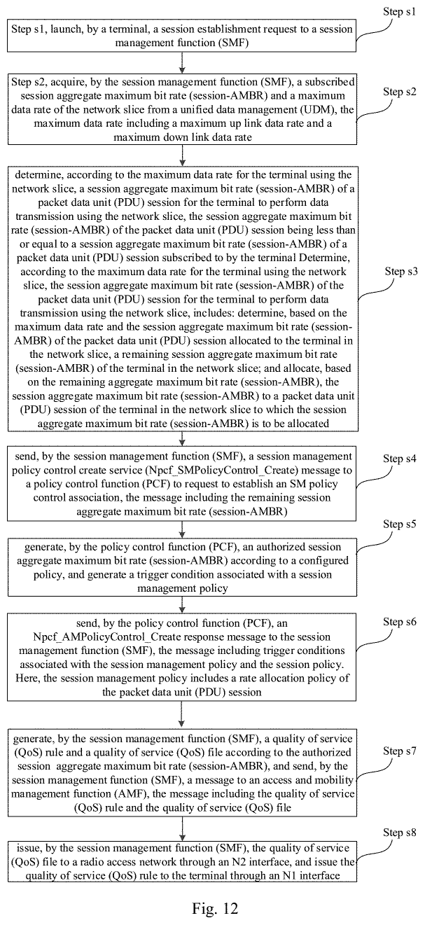

As shown in FIG. 12, an example provides a method for controlling a data transmission rate, including the following steps:

step s1, a session establishment request is launched by a terminal to a session management function (SMF).

Step s2, a subscribed session aggregate maximum bit rate (session-AMBR) and a maximum data rate of the network slice are acquired by the session management function (SMF) from a unified data management (UDM), the maximum data rate including a maximum up link data rate and a maximum down link data rate.

Step s3, according to the maximum data rate for the terminal using the network slice, a session aggregate maximum bit rate (session-AMBR) of a packet data unit (PDU) session for the terminal to perform data transmission using the network slice is determined, the session aggregate maximum bit rate (session-AMBR) of the packet data unit (PDU) session being less than or equal to a session aggregate maximum bit rate (session-AMBR) of a packet data unit (PDU) session subscribed to by the terminal. Determining, according to the maximum data rate for the terminal using the network slice, the session aggregate maximum bit rate (session-AMBR) of the packet data unit (PDU) session for the terminal to perform data transmission using the network slice, includes: based on the maximum data rate and the session aggregate maximum bit rate (session-AMBR) of the packet data unit (PDU) session allocated to the terminal in the network slice, a remaining session aggregate maximum bit rate (session-AMBR) of the terminal in the network slice is determined; and based on the remaining session aggregate maximum bit rate (session-AMBR), the session aggregate maximum bit rate (session-AMBR) is allocated to a packet data unit (PDU) session of the terminal in the network slice to which the session aggregate maximum bit rate (session-AMBR) is to be allocated.

Step s4, a session management policy control create service (Npcf_SMPolicyControl_Create) message is sent by the session management function (SMF) to a policy control function (PCF) to request to establish an SM policy control association, the message including the remaining session aggregate maximum bit rate (session-AMBR).

Step s5, an authorized session aggregate maximum bit rate (session-AMBR) is generated by the policy control function (PCF) according to a configured policy, and a trigger condition associated with a session management policy is generated.

Step s6, an Npcf_AMPolicyControl_Create response message is sent by the policy control function (PCF) to the session management function (SMF), the message including trigger conditions associated with the session management policy and the session policy. Here, the session management policy includes a rate allocation policy of the packet data unit (PDU) session.

Step s7, a quality of service (QoS) rule and a quality of service (QoS) file are generated by the session management function (SMF) according to the authorized session aggregate maximum bit rate (session-AMBR), and a message is sent by the session management function (SMF) to an access and mobility management function (AMF), the message including the quality of service (QoS) rule and the quality of service (QoS) file.

Step s8, the quality of service (QoS) file is issued by the session management function (SMF) to a radio access network through an N2 interface, and the quality of service (QoS) rule is issued to the terminal through an N1 interface.

In the example, the maximum data rate is further set for each network slice, the maximum data transmission rate of each network slice may be limited, compared with a mode of limiting merely the session aggregate maximum bit rate (session-AMBR) of the packet data unit (PDU) session and the UE aggregate maximum bit rate (UE-AMBR) of the terminal, limiting the session aggregate maximum bit rate (session-AMBR) of the packet data unit (PDU) session according to the maximum data rate of each network slice can make the data transmission rate control of the network slices more accurate, and the efficiency of data transmission in the network slice is improved.

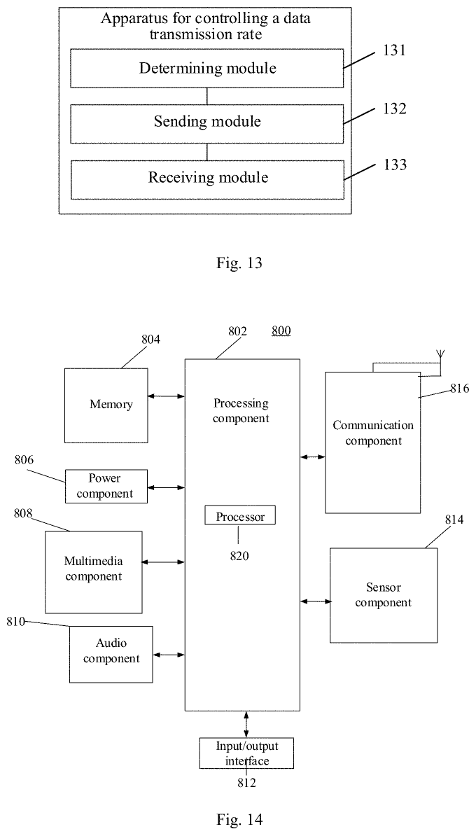

As shown in FIG. 13, an example of the disclosure provides an apparatus for controlling a data transmission rate, applied to a session management function (SMF), and the apparatus includes a determining module 131.

The determining module 131 is configured to: determine, according to a maximum data rate for a terminal using a network slice, a session aggregate maximum bit rate (session-AMBR) of a packet data unit (PDU) session for the terminal to perform data transmission using the network slice, and the session aggregate maximum bit rate (session-AMBR) of the packet data unit (PDU) session is less than or equal to a session aggregate maximum bit rate (session-AMBR) of a packet data unit (PDU) session subscribed to by the terminal.

In one example, the determining module 131 is further configured to:

determine, based on the maximum data rate and a session aggregate maximum bit rate (session-AMBR) of a packet data unit (PDU) session allocated to the terminal in the network slice, a remaining session aggregate maximum bit rate (session-AMBR) of the terminal in the network slice; and

allocate, based on the remaining session aggregate maximum bit rate (session-AMBR), the session aggregate maximum bit rate (session-AMBR) to a packet PDU session of the terminal in the network slice to which the session aggregate maximum bit rate (session-AMBR) is to be allocated.

In one example, the apparatus further includes a sending module 132.

The sending module 132 is configured to send the remaining session aggregate maximum bit rate (session-AMBR) to a policy control function (PCF), and the remaining session aggregate maximum bit rate (session-AMBR) is used for the policy control function (PCF) to formulate a rate allocation policy of the terminal.

In one example, the sending module 132 is further configured to:

send, in response to establishment of the packet data unit (PDU) session to which the session aggregate maximum bit rate (session-AMBR) is to be allocated, a session management policy control create service (Npcf_SMPolicyControl_Create) message carrying the remaining session aggregate maximum bit rate (session-AMBR) to a policy control function (PCF) that the packet data unit (PDU) session to which the session aggregate maximum bit rate (session-AMBR) is to be allocated belongs.

In one example, the apparatus further includes a receiving module 133, configured to receive a response message of a rate allocation policy carrying the packet data unit (PDU) session to which the session aggregate maximum bit rate (session-AMBR) is to be allocated and sent by the policy control function (PCF), and the rate allocation policy is formulated based on the remaining session aggregate maximum bit rate (session-AMBR).

In one example, the determining module 131 is further configured to:

allocate, based on the maximum data rate, the session aggregate maximum bit rate (session-AMBR) evenly among the plurality of packet data unit (PDU) sessions of the network slice.

In one example, the determining module 131 is further configured to:

allocate, in response to determining that a plurality of to-be-established PDU sessions are established simultaneously in the network slice, the maximum data rate evenly to the to-be-established packet data unit (PDU) sessions;

or,

allocate, in response to determining that a plurality of packet data unit (PDU) sessions are established successively in the network slice, and in response to establishment of the packet data unit (PDU) sessions each time, the maximum data rate evenly to the established packet data unit (PDU) sessions and the to-be-established packet data unit (PDU) sessions again.

In one example, the determining module 131 is further configured to:

allocate, based on the maximum data rate acquired from a unified data management UDM, the session aggregate maximum bit rate session-AMBR to the packet data unit (PDU) session of the terminal in the network slice.

In one example, the maximum data rate is a non-guaranteed quality of service (QoS) flow bit rate.

As for the apparatus in the above examples, the specific manner in which each module performs operations has been described in detail in the examples of the method, and detailed description will not be given here.

An example of the disclosure provides a communication device, including:

a processor; and

a memory, configured to store processor-executable instructions.

The processor is configured to implement the method applied to any example of the disclosure by executing the computer-executable instructions.

The processor may include storage media of various types. The storage media are non-temporary computer storage media, and can continue to memorize information stored after the communication device is powered down.

The processor may be connected with the memory via a bus and the like, and configured to read executable programs stored on the memory.

An example of the disclosure further provides a computer storage medium, storing computer-executable programs, and the computer-executable programs implement the method described by any example of the disclosure when being executed by a processor.

As for the apparatus in the above examples, the specific manner in which each module performs operations has been described in detail in the examples of the method, and detailed description will not be given here.

FIG. 14 is a block diagram of user equipment (UE) 800 illustrated according to an example. For instance, the user equipment 800 may be a mobile phone, a computer, digital broadcasting user equipment, a messaging device, a game console, a tablet device, a medical device, a fitness device, a personal digital assistant, etc.

Referring to FIG. 14, the user equipment 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls the overall operation of the user equipment 800, such as operations associated with display, telephone call, data communication, camera operations, and recording operations. The processing component 802 may include one or more processors 820 to execute instructions to complete all or part of the steps of the above method. In addition, the processing component 802 may include one or more modules to facilitate interaction between the processing component 802 and other components. For instance, the processing component 802 may include a multimedia module to facilitate interaction between the multimedia component 808 and the processing component 802.

The memory 804 is configured to store various types of data to support operations at the user equipment 800. Instances of these data include instructions for any application or method operating on the user equipment 800, contact data, phonebook data, messages, pictures, videos, etc. The memory 804 may be implemented by any type of volatile or non-volatile storage device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a disk or an optical disk.

The power component 806 provides power for various components of the user equipment 800. The power component 806 may include a power management system, one or more power sources and other components associated with generating, managing and distributing power for the user equipment 800.

The multimedia component 808 includes a screen providing an output interface between the user equipment 800 and a user. In some examples, the screen may include a liquid crystal display (LCD) and a touch panel (TP). If the screen includes the touch panel, the screen may be implemented as a touch screen to receive an input signal from the user. The touch panel includes one or more touch sensors to sense touch, sliding and gestures on the touch panel. The touch sensor can not merely sense the boundary of the touch or sliding operation, but also detect the duration and pressure related to the touch or sliding operation. In some examples, the multimedia component 808 includes a front camera and/or a rear camera. When the user equipment 800 is in an operation mode, such as a shooting mode or a video mode, the front camera and/or the rear camera can receive external multimedia data. Each front camera and rear camera may be a fixed optical lens system or have a focal length and optical zoom capability.

The audio component 810 is configured to output and/or input audio signals. For instance, the audio component 810 includes a microphone (MIC) configured to receive an external audio signal when the user equipment 800 is in the operation mode, such as a call mode, a recording mode, and a voice recognition mode. The received audio signal may be further stored in the memory 804 or transmitted via the communication component 816. In some examples, the audio component 810 further includes a speaker for outputting an audio signal.

The I/O interface 812 provides an interface between the processing component 802 and a peripheral interface module which can be a keyboard, a click wheel, a button, etc. These buttons may include but are not limited to: a home button, volume buttons, a start button and a lock button.

The sensor component 814 includes one or more sensors for providing state evaluation of various aspects of the user equipment 800. For instance, the sensor component 814 can detect an on/off state of the equipment 800 and the relative positioning of the components, for example, the component is a display and a keypad of the user equipment 800. The sensor component 814 can also detect the change of the position of the user equipment 800 or one component of the user equipment 800, the presence or absence of user contact with the user equipment 800, the azimuth or acceleration/deceleration of the user equipment 800, and temperature change of the user equipment 800. The sensor component 814 may include a proximity sensor configured to detect the presence of nearby objects without any physical contact. The sensor component 814 may further include an optical sensor, such as a CMOS or CCD image sensor, for use in imaging applications. In some examples, the sensor component 814 may further include an acceleration sensor, a gyroscope sensor, a magnetic sensor, a pressure sensor, or a temperature sensor.

The communication component 816 is configured to facilitate wired or wireless communication between the user equipment 800 and other devices. The user equipment 800 may access a wireless network based on a communication standard, such as Wi-Fi, 2G or 3G, or their combination. In an example, the communication component 816 receives a broadcast signal or broadcast-related information from an external broadcast management system via a broadcast channel In an example, the communication component 816 further includes a near field communication (NFC) module to facilitate short-range communication. For instance, the NFC module may be implemented based on a radio frequency identification (RFID) technology, an infrared data association (IrDA) technology, an ultra wideband (UWB) technology, a Bluetooth (BT) technology and other technologies.

In an example, the user equipment 800 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components for executing the above method.

In an example, a non-transitory computer-readable storage medium including instructions is further provided, such as the memory 804 including instructions, which can be executed by the processor 820 of the user equipment 800 to complete the above method. For instance, the non-temporary computer-readable storage medium may be an ROM, a random access memory (RAM), a CD-ROM, a magnetic tape, a floppy disk, an optical data storage device, etc.

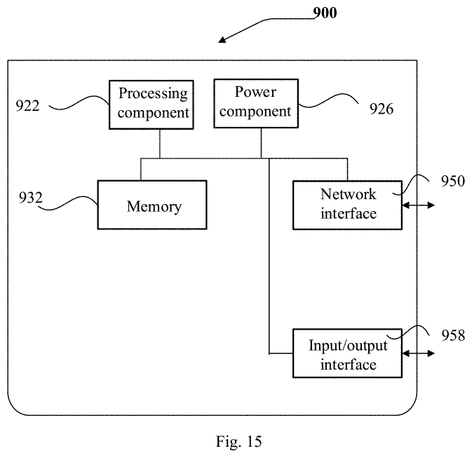

As shown in FIG. 15, an example of the disclosure provides a structure of a base station. For instance, the base station 900 may be provided as a network-side device. Referring to FIG. 15, the base station 900 includes a processing component 922, which further includes one or more processors, and a memory resource represented by a memory 932, which is configured to store instructions, such as applications, executable by the processing component 922. The applications stored in the memory 932 may include one or more modules each corresponding to a set of instructions. In addition, the processing component 922 is configured to execute instructions to execute any of the methods applied to the base station, such as the methods shown in FIGS. 2-6.

The base station 900 may further include the power component 926 configured to execute power management of the base station 900, a wired or wireless network interface 950 configured to connect the base station 900 to the network, and an input/output (I/O) interface 958. The base station 900 may operate an operating system stored in the memory 932, such as Windows Server™, Mac OS X™, Unix™, Linux™, FreeBSD™ and the like.

Other examples of the disclosure will be apparent to those skilled in the art from consideration of the specification and practice of the disclosure here. The disclosure is intended to cover any variations, uses, or adaptations of the disclosure following the general principles of the disclosure and including such departures from the disclosure as come within known or customary practice in the art. It is intended that the specification and examples be considered as examples merely, with a true scope and spirit of the disclosure being indicated by the following claims.

It will be appreciated that the disclosure is not limited to the exact construction that has been described above and illustrated in the accompanying drawings, and that various modifications and changes may be made without departing from its scope. It is intended that the scope of the disclosure only be limited by the appended claims.

1. A method for controlling a data transmission rate, performed by a session management function (SMF), the method comprising:
determining, according to a maximum data rate for a terminal using a network slice, a session aggregate maximum bit rate (session-AMBR) of a packet data unit (PDU) session for the terminal to perform data transmission using the network slice, wherein the session-AMBR of the PDU session is less than or equal to a session-AMBR of a PDU session subscribed to by the terminal.

2. The method according to claim 1, wherein determining, according to the maximum data rate for the terminal using the network slice, the session aggregate maximum bit rate (session-AMBR) of the packet data unit (PDU) session for the terminal to perform data transmission using the network slice comprises:
determining, based on the maximum data rate and the session-AMBR of the PDU session allocated to the terminal in the network slice, a remaining session-AMBR of the terminal in the network slice; and
allocating, based on the remaining session-AMBR, a session-AMBR to a PDU session of the terminal in the network slice to which the session-AMBR is to be allocated.

3. The method according to claim 2, further comprising:
sending the remaining session-AMBR to a policy control function (PCF), wherein the remaining session-AMBR is used for the PCF to formulate a rate allocation policy of the terminal.

4. The method according to claim 3, wherein sending the remaining session-AMBR to the policy control function (PCF), comprises:
sending, in response to establishment of the PDU session to which the session-AMBR is to be allocated, a session management policy control create service (Npcf_SMPolicyControl_Create) message carrying the remaining session-AMBR to the PCF that the PDU session to which the session-AMBR is to be allocated belongs.

5. The method according to claim 3, further comprising:
receiving a response message of the rate allocation policy carrying the PDU session to which the session-AMBR is to be allocated and sent by the PCF, wherein the rate allocation policy is formulated based on the remaining session-AMBR.

6. The method according to claim 1, wherein determining, according to the maximum data rate for the terminal using the network slice, the session aggregate maximum bit rate (session-AMBR) of the packet data unit (PDU) session for the terminal to perform data transmission using the network slice comprises:
allocating, based on the maximum data rate, the session-AMBR evenly among a plurality of PDU sessions of the network slice.

7. The method according to claim 6, wherein allocating the session-AMBR evenly among the plurality of PDU sessions of the network slice, comprises at least one of the following:
allocating, in response to determining that a plurality of to-be-established PDU sessions are established simultaneously in the network slice, the maximum data rate evenly to the plurality of to-be-established PDU sessions; and
allocating, in response to determining that a plurality of PDU sessions are established successively in the network slice, and in response to establishment of the PDU sessions each time, the maximum data rate evenly to the established PDU sessions and the plurality of to-be-established PDU sessions again.

8. The method according to claim 1, wherein determining, according to the maximum data rate for the terminal using the network slice, the session aggregate maximum bit rate (session-AMBR) of the packet data unit (PDU) session for the terminal to perform data transmission using the network slice comprises:
allocating, based on the maximum data rate acquired from a unified data management (UDM), the session aggregate maximum bit rate (session-AMBR) to the packet data unit (PDU) session of the terminal in the network slice.

9. The method according to claim 1, wherein the maximum data rate is a non-guaranteed quality of service (QoS) flow bit rate.

10. (canceled)

11. (canceled)

12. (canceled)

13. A communication device, comprising:
an antenna;
a memory; and
a processor, connected to the antenna and the memory respectively, wherein the processor is configured to control transceiving of the antenna by executing computer-executable instructions stored in the memory, and wherein the processor is further configured to execute the computer-executable instructions to:
determine, according to a maximum data rate for a terminal using a network slice, a session aggregate maximum bit rate (session-AMBR) of a packet data unit (PDU) session for the terminal to perform data transmission using the network slice, wherein the session-AMBR of the PDU session is less than or equal to a session-AMBR of a PDU session subscribed to by the terminal.

14. A non-transitory computer storage medium, storing computer-executable instructions, wherein the computer-executable instructions can implement steps of:
determining, according to a maximum data rate for a terminal using a network slice, a session aggregate maximum bit rate (session-AMBR) of a packet data unit (PDU) session for the terminal to perform data transmission using the network slice, wherein the session-AMBR of the PDU session is less than or equal to a session-AMBR of a PDU session subscribed to by the terminal.

15. The communication device according to claim 13, wherein the processor is further configured to execute the computer-executable instructions to:
determine, based on the maximum data rate and the session-AMBR of the PDU session allocated to the terminal in the network slice, a remaining session-AMBR of the terminal in the network slice; and
allocate, based on the remaining session-AMBR, a session-AMBR to a PDU session of the terminal in the network slice to which the session-AMBR is to be allocated.

16. The communication device according to claim 15, the processor is further configured to execute the computer-executable instructions to:
send the remaining session-AMBR to a policy control function (PCF), wherein the remaining session-AMBR is used for the PCF to formulate a rate allocation policy of the terminal.

17. The communication device according to claim 16, the processor is further configured to execute the computer-executable instructions to:
send, in response to establishment of the PDU session to which the session-AMBR is to be allocated, a session management policy control create service (Npcf_SMPolicyControl_Create) message carrying the remaining session-AMBR to the PCF that the PDU session to which the session-AMBR is to be allocated belongs.

18. The communication device according to claim 16, the processor is further configured to execute the computer-executable instructions to:
receive a response message of the rate allocation policy carrying the PDU session to which the session-AMBR is to be allocated and sent by the PCF, wherein the rate allocation policy is formulated based on the remaining session-AMBR.

19. The communication device according to claim 13, the processor is further configured to execute the computer-executable instructions to:
allocate, based on the maximum data rate, the session-AMBR evenly among a plurality of PDU sessions of the network slice.

20. The communication device according to claim 19, the processor is further configured to execute the computer-executable instructions to perform at least one of the following actions:
allocating, in response to determining that a plurality of to-be-established PDU sessions are established simultaneously in the network slice, the maximum data rate evenly to the to-be-established PDU sessions; and
allocating, in response to determining that a plurality of PDU sessions are established successively in the network slice, and in response to establishment of the PDU sessions each time, the maximum data rate evenly to the established PDU sessions and the plurality of to-be-established PDU sessions again.

21. The communication device according to claim 13, the processor is further configured to execute the computer-executable instructions to:
allocate, based on the maximum data rate acquired from a unified data management (UDM), the session aggregate maximum bit rate (session-AMBR) to the packet data unit (PDU) session of the terminal in the network slice.

22. The communication device according to claim 13, wherein the maximum data rate is a non-guaranteed quality of service (QoS) flow bit rate.
